(19) United States
(12) Patent Application Publication
(10) Pub. No.: US 2007/0049074 A1
(43) Pub. Date: Mar. 1, 2007

(54) [ELASTIC EARTHING PLATE FOR SERVER CASE]

(75) Inventor: Chih-Liang Fang, TAIPEI (TW)

Correspondence Address: ADLINK TECHNOLOGY INC., P.O. BOX 108-00403, TAIPEI, TW

(73) Assignee: ADLINK TECHNOLOGY INC., Chungho City (TW)

(21) Appl. No.: 11/162,002

(22) Filed: Aug. 25, 2005

(51) Int. Cl. H01R 13/648

(52) U.S. Cl. 439/108

(57) ABSTRACT

An elastic earthing plate for a server case is provided. The elastic earthing plate comprises two buckling portions formed on two sides thereof for respectively buckling to corresponding sidewalls of tracks for positioning. Each buckling portion comprises an extended arm at a distal end thereof for clamping a base plate to avoid displacement or shock occurring during the sliding of the base plate in the track, and thereby secure the base plate in the case. Thus, it is not only possible to form a reliable earthing loop between the base plate and the arm but also to position the base plate between the two arms of the elastic earthing plate to substantially ensure the earthing effect. The assembly and disassembly of the elastic earthing plate may also be easily implemented.

### BACKGROUND OF INVENTION

1. Field of the Invention

The present invention relates to an elastic earthing plate for a server case and more particularly, to an elastic earthing plate applied in the ATCA server case which can be buckled into a track located in the ATCA case tightly held a base plate to assure better earthing effect.

2. Background of the Related Art

Presently, a plurality of low cost small servers is being used for the server network. Among such servers, a blade server is more economical. The blade server is to integrate the processor, memory and hard disk into a single circuit board.

The blade server case can receive a plurality of blade server plates; one blade server plate is equivalent to one server, and these blade server plates share the server case, the monitor, the keyboard, the power supply and other accessories to substantially integrate a large database. Furthermore, the server case comprises a system to provide information related to internal database, and the system can separate blade server plate resources and specific jobs of the network or the appliance programs executed by the blade server plate to enable the blade server plates in the server case to have more flexibility in use.

The most attractive part of the blade server is the high reliability and expandability because each blade server plate contains backup function, as well as the case supports the hot plug function of the blade server plate and the system components to make the blade server more valuable. If one of the blade server plates breaks down, another blade server plate may be able to replace it without interrupting the operation. If a user wishes to upgrade the ability, the use may merely need to insert additional blade server plates into the blade server case.

Because the blade server provides hot plug function, therefore the plug-in frequency substantially higher than the conventional server. The case includes a receiving space that has a plurality of tracks symmetrically provided at two sides therein and an opening at a front side. Each track comprises a sliding channel for positioning the blade server plate into the receiving space along the sliding channel of the track, and the blade server plate fastened to the blade server case by using screws to substantially secure the blade server plate to the blade server case. However, because the distance between the two sidewalls of the sliding channel of the track is larger than the thickness of the blade server plate, therefore when inserting the blade server plate into the track, the blade server plate may be displacement or shock which may result in undesirable contact between the two adjacent blade server plates causing damage to the electronic components of the blade server plate. Furthermore, the blade server plate comprises an elastic earthing plate to form an earthing loop with the blade server case, however such a connection is very inconvenient to the user upon replacing the blade server plate, the elastic earthing plate can easily come off from the position or even may get dislocated due to the environmental or human faults. Besides, there is only one contact side between the blade server plate and the case, often plug-in and unplugging may easily cause loss of elasticity of the elastic earthing plate and the earthing effect may fail.

### SUMMARY OF THE INVENTION

Accordingly, in the view of the foregoing, the present inventor makes a detailed study of related art to evaluate and consider, and uses years of accumulated experience in this field, and through several experiments, to create an elastic earthing plate capable of being tightly held the base plate for providing better earthing effect.

According to an aspect of the present invention, the elastic earthing plate comprises two buckling portions formed at two sides thereof for buckling to corresponding sidewalls of a track for positioning. Each buckling portion comprises an extended arm at a distal end thereof for clamping a base plate to avoid displacement or shock occurring during the sliding of the base plate in the track, and thereby secure the base plate in case. The two arms are positioned against the two sides of the base plate positioned in a sliding channel of the track. Thus, it is not only possible to form a reliable earthing loop between the base plate and the arms but also to position the base plate between the two arms of the elastic earthing plate to substantially ensure the earthing effect. To assemble the elastic earthing plate, the user may only need to apply a downward force on the top of the elastic earthing plate to buckle the elastic earthing plate in the track. And, for disassemble the elastic earthing plate from the track; the user may only need to use an outward force at the buckling portions of the elastic earthing plate to disassemble the elastic earthing plate from the track. Thus, the assembly and disassembly of the elastic earthing plate may be easily implemented.

### BRIEF DESCRIPTION OF THE DRAWING

For a more complete understanding of the present invention, reference will now be made to the following detailed description of preferred embodiments taken in conjunction with the following accompanying drawings.

FIG. 1 is an elevational view of an elastic earthing plate according to an embodiment of the present invention.

FIG. 2 is a view illustrating the elastic earthing plate buckled in the track according to an embodiment of the present invention.

FIG. 3 is a view illustrating the actual application of the elastic earthing plate in the case according to an embodiment of the present invention (I).

FIG. 4 is a view illustrating the actual application of the elastic earthing plate in the case according to an embodiment of the present invention (II).

FIG. 5 is view illustrating clamping the base plate in the elastic earthing plate according to an embodiment of the present invention.

FIG. 6 is a view illustrating the elastic earthing plate buckled in the track according to another embodiment of the present invention.

FIG. 7 is a view illustrating clamping the base plate in the elastic earthing plate according to another embodiment of the present invention.

### DETAILED DESCRIPTION OF EMBODIMENTS

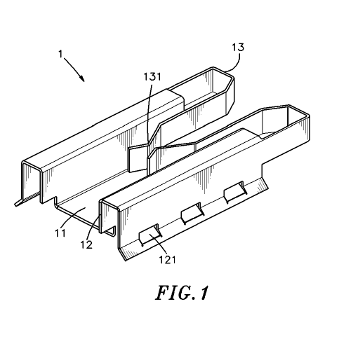

Referring to FIG. 1, an elastic earthing plate 1 in accordance with the present invention is shown comprised of a flat base 11, two buckling portions 12 and two arms 13.

The base 111 has the buckling portions 12 bent at a distal end of two lateral sides thereof respectively. Each of the buckling portions 12 comprises one or more than one securing portion 121 at a bottom portion thereof, and each of the arms 13 extends from a side of the buckling portion 12 towards a central portion of the base 11.

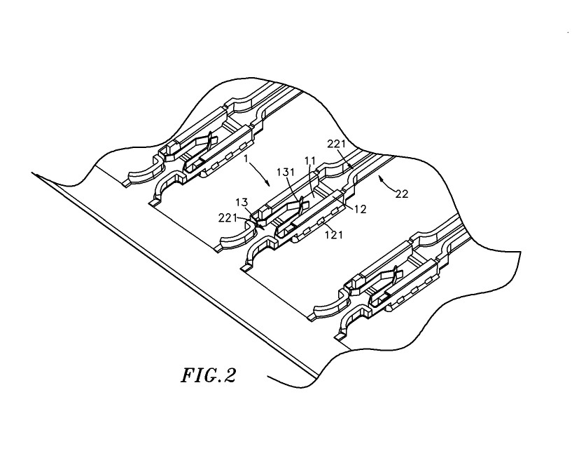

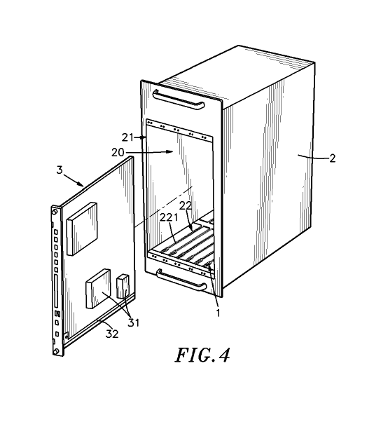

Referring to FIGS. 2, 3 and 4, a case 2 comprises a receiving space 20 and a plurality of base plates 3 is fixed mounted in the receiving space 20 of the case, which has electronic components 31 and an earthing point 32 disposed thereon. The receiving space 20 comprises an opening 21 at a front side and a plurality of tracks 22 symmetrically transversely provided at two sides insides the receiving space 20. Each of the tracks 22 comprises a sliding channel 221, wherein the elastic earthing plate 1 is positioned in a front side of the track 22 of the case 2. The buckling portions 12 of the elastic earthing plate 1 are adopted for buckling to the corresponding sidewalls of the track 22 by positioning the securing portions 121 against the sidewalls of the track 22. The two arms 13 are positioned at the sliding channel 221 of the track 22. Accordingly, for assembling the elastic earthing plate 1 in the track 22, the elastic plate 1 may be placed on the track 22 and then a downward force may be applied on the top of the elastic earthing plate 1 to easily buckle the elastic earthing plate 1 in the track 22; for disassembling or releasing the elastic earthing plate 1 from the track 22, an outward force may be applied to the buckling portions 12 of the elastic earthing plate 1 to easily disassemble or release the elastic earthing plate 1 from the track 22.

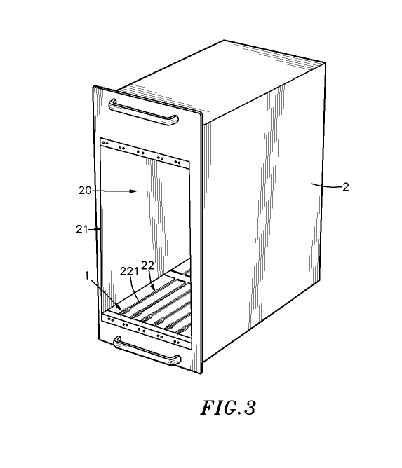

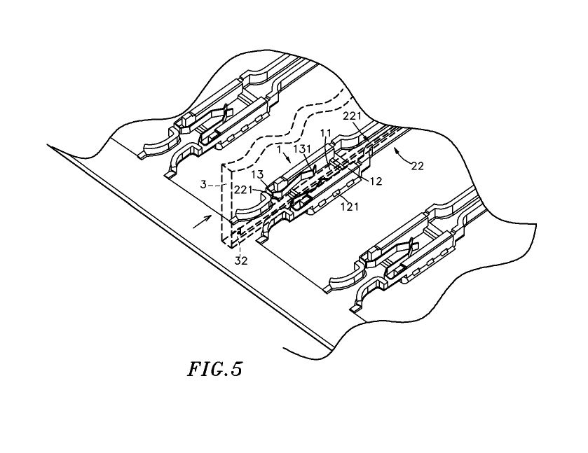

Reference to FIGS. 3, 4 and 5, when assembly the base plate 3 into the case 2 from the opening 21, the base plate 3 slides along the sliding channel 221 of the track 22 into the receiving space 20. By doing so, the arms 13 of the elastic earthing plate 1 respectively clamp the two sides of the base plate 3 and thereby avoid displacement or shock from occurring during the sliding of the base plate 3 in the track 22. Thus, the base plate 3 is securely positioned in the receiving space 20. The arms 13 of the elastic earthing plate 1 form an earthing loop with the earthing point 32 of the base plate 3, and are supported against the base plate 3 at two sides. The advantage of this design is that even when one of the arms 13 losses elasticity due to reuse, the arms 13 formed at the other side can still support the base plate 3 to ensure earthing effect.

Referring to FIGS. 1, 2 and 5, an arch portion 131 may be further formed on each arm 13. When the base plate 3 is pushed from the opening 21 of the case 2, the base plate 3 can easily slide along the sliding channel 221 of the track 22 and position within the receiving space 20, and the arch portions 131 of the arms 13 securely clamp the base plate 3 and form the earthing loop with the earthing point 32 of the base plate 3. Thus, the two sides of the base plate 3 are securely clamped by the arms 13 of the elastic earthing plate 1 to ensure the earthing effect.

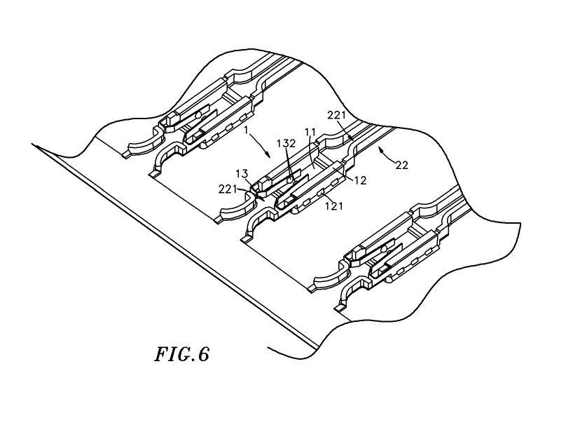

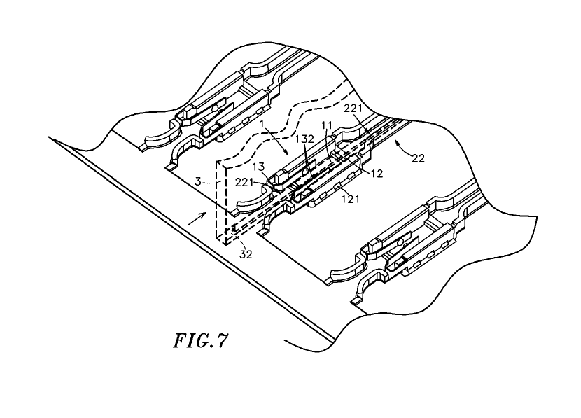

Referring to FIGS. 6 and 7, each arm 13 of the elastic earthing plate 1 may further comprise a protrusion 132 for clamping the base plate 3. When the base plate 3 is pushed into the case 2 from the opening 21 and slides along the sliding channel 21 of the track 22 to position in the receiving space 20, the protrusions 132 formed on the arms 13 clamp the base plate 3 and form the earthing loop with the earthing point 32 of the base plate 3. Thus, the two sides of the base plate 3 can be tightly clamped by the arms 13 of the elastic earthing plate 1 to ensure the earthing effect.

Accordingly, as described above, the present invention provides arch portions or protrusions disposed on the arms for merely positioning the base plate in the receiving space of the case, and form the earthing loop with the earthing point of the base plate. Therefore, the arch portions or the protrusions disposed on the arms may be replaced with other equivalent elements for providing the same effect.

Accordingly, the elastic earthing plate for the server case, according to the present invention, has at least the following advantages.

1. The assembly and disassembly of the elastic earthing plate may be simplified. For assembling the elastic earthing plate in the track, the elastic plate may be placed on the track and then a downward force may be applied on the top of the elastic earthing plate to easily buckle the elastic earthing plate in the track. For disassembling the elastic earthing plate from the track, an outward force may be applied to the buckling portions of the elastic earthing plate to easily disassemble the elastic earthing plate from the track.

2. The buckling portions of the elastic earthing plate are adopted for buckling to the corresponding sidewalls of the track. Thus, the elastic earthing plate can be firmly positioned in the track to avoid displacement or shock from occurring during the process of plugging-in or unplugging the base plate.

3. The arms of the elastic earthing plate are adopted for supporting against the two sides of the base plate when sliding the base plate in the sliding channel of the track, therefore the base plate can be firmly clamped between the two arms of the elastic earthing plate and form the earthing loop with the earthing point to ensure the earthing effect.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. An elastic earthing plate for a server case, the case comprising:
a receiving space, for receiving a plurality of base plates, having an opening at a front side thereof and a plurality of tracks symmetrically transversely disposed at two sides, and said each track comprising a sliding channel, wherein a plurality of base plates are pushed into said receiving space of said case from said opening along said sliding channels of said tracks so that said base plates are positioned in said receiving space, and wherein said base plates comprises an earthing point at a bottom side thereof;
wherein said elastic earthing plate is disposed in said track inside said case, said elastic earthing plate comprising:
a base comprising buckling portions respectively positioned at two sides thereof, wherein said buckling portions are adopted for buckling to corresponding sidewalls of said one track in said receiving space for positioning;
two arms, formed extending from two side of said buckling portions respectively for clamping said base plate, wherein said arms positioned in said sliding channels of said tracks are adopted for contacting with said earthing point of said base plate for forming an earthing loop.

2. The elastic earthing plate for a server case according to claim 1, wherein said base plate comprises a plurality of electronic components disposed thereon.

3. The elastic earthing plate for a server case according to claim 1, wherein each of said arms of said elastic earthing plate comprises an arch portion at a side thereof.

4. The elastic earthing plate for a server case according to claim 1, wherein each of said arms of said elastic earthing plate comprises protrusion at a side thereof for clamping said base plate.

5. The elastic earthing plate for a server case according to claim 1, wherein said buckling portion comprises one or more securing portions disposed thereon.
